(19) United States
(12) Patent Application Publication
(10) Pub. No.: US 2018/0219949 A1
(43) Pub. Date: Aug. 2, 2018

(54) METHOD FOR AUTOMATICALLY CONTROLLING NETWORK ACCESS USING API MAP IN CLOUD-BASED VEHICLE ENVIRONMENT AND DEVICE USING THE SAME

(71) Applicant: Obigo Inc., Gyeonggi-do (KR)

(72) Inventors: Jung Seok Lee, Daegu (KR); Kihyun Jo, Seoul (KR)

(21) Appl. No.: 15/418,671

(22) Filed: Jan. 27, 2017

(51) Int. Cl. H04L 29/08

(52) U.S. Cl. CPC H04L 67/141; H04L 67/10; H04L 67/12; H04L 67/34

(57) ABSTRACT

A method for automatically controlling a network access by using an API map in a cloud-based environment of a vehicle is provided. The method includes steps of: (a) an access control device transmitting or supporting other device to transmit information on a current version of an access API specification used by the vehicle to a cloud server to support the cloud server to check whether there is a new version being used; (b) the access control device, if it is determined that there is the new version used in the cloud server, acquiring the new version and creating a parse tree by parsing the acquired new version; and (c) the access control device creating API instances corresponding to APIs included in the new version by referring to the parse tree and registering the created API instances in the API map.

### FIELD OF THE INVENTION

The present invention relates to a method and a device for automatically controlling a network access by using an application programming interface (API) map in a cloud-based environment of a vehicle, and more particularly, the method and the device for automatically controlling the network access by using the API map in the cloud-based environment of the vehicle under which an access control device creates a parse tree by acquiring and parsing a new version of an access API specification being used by the vehicle, if there is the new version of the access API specification, creates one or more API instances corresponding to one or more APIs included in the new version of the access API specification by referring to the created parse tree, and registers the one or more APIs in the API map so that the API instances are available for a user interface of the vehicle.

### BACKGROUND OF THE INVENTION

As interest in autonomous vehicles is rising, studies on connected cars are also becoming more active. A connected car is a concept of a car which provides safety and convenience for drivers while communicating with its surroundings in real time and it emphasizes vehicle connectivity and Internet of Things (IoT) is adapted to vehicles and used as a platform.

In particular, the cloud is used to improve service quality of smart cars including autonomous vehicles and connected cars. Smart cars can sometimes receive information on a variety of geographical features from the cloud and check traffic conditions in real time. Besides, even a variety of data collected by vehicles may be stored in the cloud and vehicles may have access to even information used at home or by smart phones through the cloud.

In the cloud-based vehicle environment, users may constantly use services including contents such as music, emails, documents, newspapers, videos in all spaces including cars. Besides, information including real-time detection of a failure in a car engine and a rapid traffic guide is provided for vehicle makers and drivers through the cloud and information on vehicles can be predicted to help vehicle maintenance.

Conventionally, at the time when vehicles are manufactured and released, an operating structure of software regarding functions which use the cloud and vehicle communication systems to communicate with the cloud is decided. When the functions are changed in the future or new functions are added, such changed or new functions cannot be used. Accordingly, users must update a whole or partial software package of the vehicles online, or offline at service centers, etc. to make such services work properly.

Additionally, even after the update, if another problem occurs or it is urgently needed to change a function, such issues must be handled through the same procedure and this causes a huge cost to vehicle owners and service providers.

### SUMMARY OF THE INVENTION

It is an object of the present invention to solve all the aforementioned problems.

It is another object of the present invention to establish a cloud-based vehicle environment which does not use a software package whose functions are fixed.

It is still another object of the present invention to allow cloud access without any separate external processing.

In accordance with one aspect of the present invention, there is provided a method for automatically controlling a network access by using an API map in a cloud-based environment of a vehicle, including steps of: (a) an access control device transmitting or supporting other device to transmit information on a current version of an access API specification being used by the vehicle to a cloud server to support the cloud server to check whether there is a new version of the access API specification being used; (b) the access control device, if it is determined that there is the new version of the access API specification being used in the cloud server, acquiring the new version of the access API specification and creating a parse tree by parsing the acquired new version of the access API specification; and (c) the access control device creating one or more API instances corresponding to one or more APIs included in the new version of the access API specification by referring to the parse tree and registering the created API instances in the API map so that the API instances are available for a user interface of the vehicle.

In accordance with another aspect of the present invention, there is provided an access control device for automatically controlling a network access by using an API map in a cloud-based environment of a vehicle, including: a communication part for transmitting or supporting other device to transmit information on a current version of an access API specification being used by the vehicle to a cloud server to support the cloud server to check whether there is a new version of the access API specification being used; and a processor for (i) acquiring the new version of the access API specification, if it is determined that there is the new version of the access API specification being used in the cloud server, and creating a parse tree by parsing the acquired new version of the access API specification and (ii) creating one or more API instances corresponding to one or more APIs included in the new version of the access API specification by referring to the parse tree and registering the created API instances in the API map so that the API instances are available for a user interface of the vehicle.

### BRIEF DESCRIPTION OF THE DRAWINGS

Drawings necessary to be used to explain embodiments to show technical solutions more clearly in embodiments of the present invention will be described briefly. Clearly, the drawings presented as shown below are just part of the embodiments of the present invention and other drawings will be able to be obtained based on the drawings without inventive work for those skilled in the art:

FIG. 1 schematically illustrates an access control device that automatically controls a network access by using an API map in a cloud-based environment of a vehicle in accordance with one example embodiment of the present invention.

FIG. 2 schematically shows a method for automatically controlling a network access by using an API map in a cloud-based environment of a vehicle in accordance with one example embodiment of the present invention.

FIG. 3 depicts one example of an access API specification under a method for automatically controlling a network access by using an API map in a cloud-based environment of a vehicle in accordance with one example embodiment of the present invention.

FIG. 4 illustrates one example of parsing an access API specification under a method for automatically controlling a network access by using an API map in a cloud-based environment of a vehicle in accordance with one example embodiment of the present invention.

FIG. 5 shows one example of a created API instance by using a result of parsing in

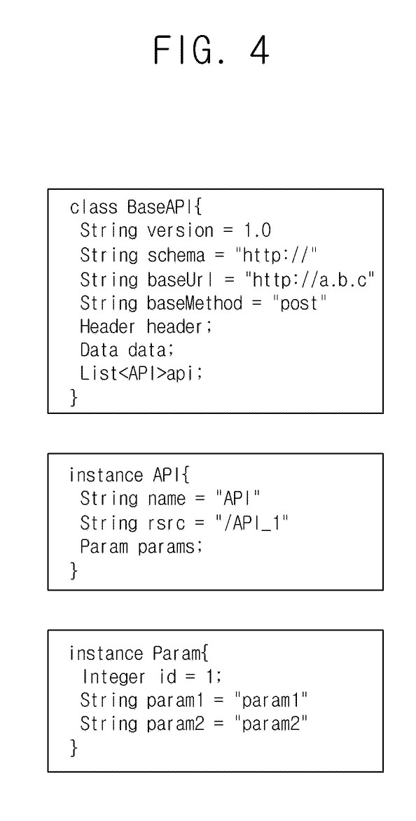

FIG. 4 under a method for automatically controlling a network access by using an API map in a cloud-based environment of a vehicle in accordance with one example embodiment of the present invention.

FIG. 6 illustrates another example of an access API specification under a method for automatically controlling a network access by using an API map in a cloud-based environment of a vehicle in accordance with one example embodiment of the present invention.

### DETAILED DESCRIPTION OF THE PREFERRED EMBODIMENTS

Detailed description of embodiments in which the invention may be practiced will be discussed by referring to attached drawings. These embodiments are described in sufficient detail to enable those skilled in the art to practice the invention. It is to be understood that the various embodiments of the present invention, although different, are not necessarily mutually exclusive. For example, a particular feature, structure, or characteristic described herein in connection with one embodiment may be implemented within other embodiments without departing from the spirit and scope of the present invention. In addition, it is to be understood that the position or arrangement of individual elements within each disclosed embodiment may be modified without departing from the spirit and scope of the present invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

These embodiments will be described in sufficient detail by referring to attached drawings regarding the embodiments of the present invention to enable those skilled in the art to practice the invention.

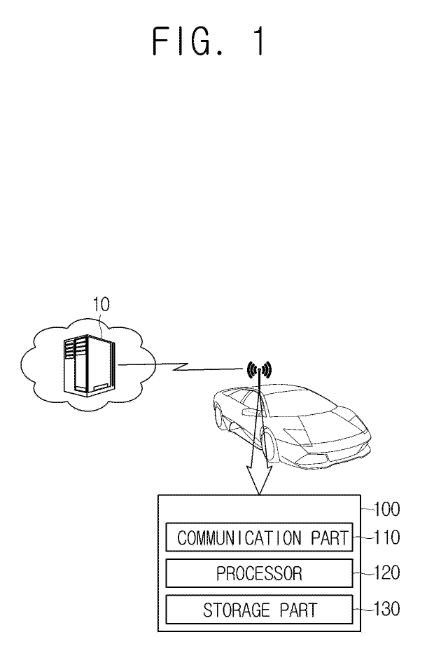

FIG. 1 schematically illustrates an access control device that automatically controls a network access by using an API map in a cloud-based environment of a vehicle in accordance with one example embodiment of the present invention. By referring to FIG. 1, the access control device 100 may include a communication part 110, a processor 120, and a storage part 130.

First of all, the communication part 110 may transmit or support other device to transmit information on a current version of an access API specification being used by the vehicle to a cloud server 10 to support the cloud server 10 to check whether there is a new version of the access API specification.

At the time, the communication part 110 may have access to the cloud server 10 through a network, which may be implemented as all types of wireless networks such as Local Area Network (LAN), Metropolitan Area Network (MAN), Wide Area Network (WAN), Value Added Network (VAN), Personal Area Network (PAN), mobile radio communication network, Wireless Broadband Internet (Wibro), Mobile WiMAX, High Speed Downlink Packet Access (HSDPA), Zigbee, Ultra-WideBand (UWB) or satellite network.

Next, if it is determined that there is the new version of the access API specification being used in the cloud server 10, the processor 120 may acquire the new version of the access API specification and create a parse tree by parsing the acquired new version of the access API specification. In addition, it may create one or more API instances corresponding to one or more APIs included in the new version of the access API specification by referring to the parse tree and register the created API instances in the API map so that the API instances are available for a user interface of the vehicle.

At the time, if it is determined that there is the new version of the access API specification being used and if download information of the new version of the access API specification is acquired from the cloud server 10, the processor 120 may download and acquire the new version of the access API specification corresponding to the download information. Besides, if it is determined that there is the new version of the access API specification being used in the cloud server 10 and if the new version of the access API specification is transmitted from the cloud server 10, the processor 120 may receive and acquire the new version of the access API specification transmitted from the cloud server 10.

Next, the storage part 130 may store programs or data required to operate the processor 120, data created by the operation, etc.

Herein, the storage part 130 may be embedded in the access control device 100 or be detachable.

The storage part 130 may include flash memory, a hard disk, memory cards (e.g., an SD memory card, an XD memory card, etc.), Random Access Memory (RAM), Static Random Access Memory (SRAM), Read Only Memory (ROM), Electrically Erasable Programmable Read Only Memory (EEPROM), Programmable Read Only Memory (PROM), Magnetic Random Access Memory (MRAM), a magnetic disk, an optical disk, etc. Additionally, the storage part 130 may be a single medium or be composed of multiple media.

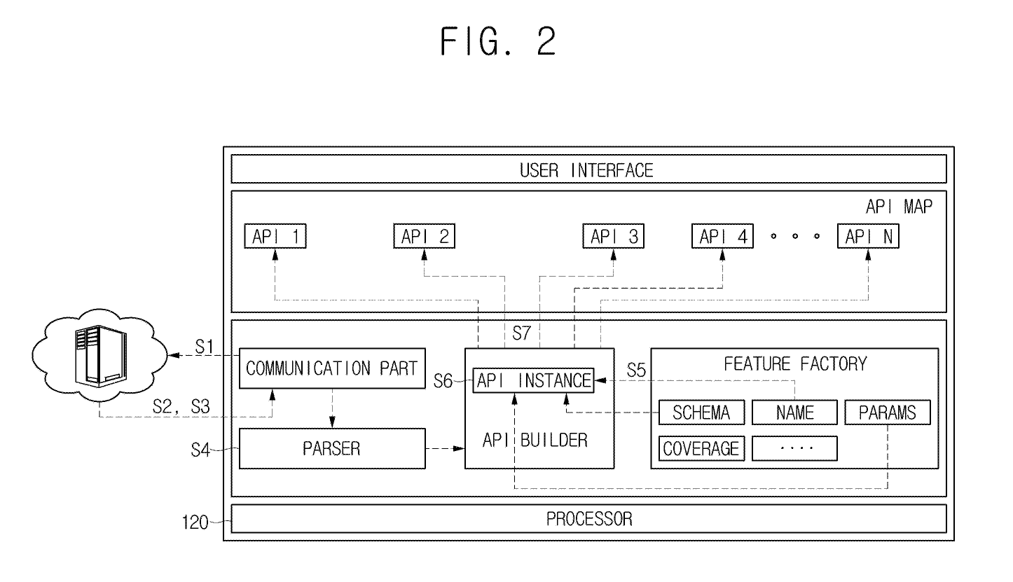

Below will be explanation on the method for automatically controlling the network access by using the API map in the cloud-based environment of the vehicle through the access control device 100 in accordance with one example embodiment of the present invention by referring to FIGS. 1 to 6.

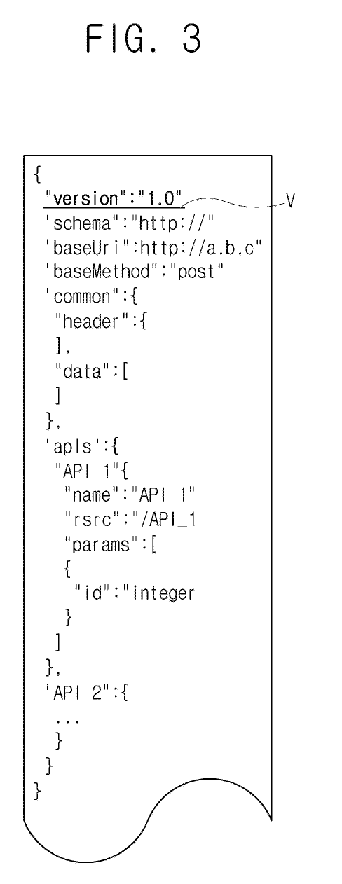

First of all, in the cloud-based environment of the vehicle where API instances API1, API2, API3, API4, . . . , and APIN created by the access API specification as shown in FIG. 3 or 6 are registered in the API map so that the API instances are available through a user interface of the vehicle, the communication part 110 of the access control device 100 may transmit or support other device to transmit information on a current version of the access API specification being used by the vehicle to the cloud server 10 at the step of S1 and support the cloud server 10 to check whether there is the new version of the access API specification now being used by the vehicle.

In short, the processor 120 of the access control device 100 may acquire information on the current version of the access API specification stored in the storage part 130 corresponding to API instances API1, API2, API3, API4, . . . , and APIN registered in the API map of the storage part 130 and transmit the acquired information on the current version to the communication part 110. Furthermore, the communication 110 transmits the information on the current version to the cloud server 10. The cloud server 10 checks whether the version of the access API specification now registered therein is new in comparison with the information on the current version transmitted from the access control device 100 with information on the version V of the access API specification as shown in FIG. 3 or 6 registered therein.

At the moment, the access API specification may be a language that defines an interface of an already existing API. Also, it may be a language that defines an interface of a new type or a function of an API.

The API instances API1, API2, API3, API4, . . . , and APIN may perform a function of providing a user with safety information, infotainment information, etc. regarding an operation of the vehicle by accessing the cloud. As an example, they may perform functions of providing traffic information about a road on which the vehicle runs and information about incidents, etc., information about a map, a location, etc. for an automotive navigation system, information about available parking spaces and of locating the nearest gas station when the vehicle is running out of gas.

Besides, the access control device 100 may cause the operation to be performed through a communication with the cloud server 10 when power of the vehicle is fed. In other words, if the API is being upgraded while the vehicle is running or a user in the vehicle is using the function of the API by accessing the cloud, the function of the API cannot be used and this may cause an accident or user inconvenience. Therefore, upgrade is processed when the power of the vehicle is fed, in order to keep vehicle safety and user convenience.

If it is determined that there is the new version in the cloud server 10 of the access API specification now being used by the vehicle, the access control device 100 may acquire the new version of the access API specification as shown in FIG. 3 or 6 at the steps of S2 and S3 and create the parse tree by parsing the acquired new version of the access API specification at the step of S4.

As one example, if it is determined that there is the new version in the cloud server 10 of the access API specification now being used by the vehicle, the download information of the new version of the access API specification is transmitted to the access control device 100 at the step of S2. Then, the access control device 100 may download and acquire the new version of the access API specification in response to the download information transmitted from the cloud server 10 at the step of S3. At the time, the new version of the API specification corresponding to the download information may be registered in the cloud server 10 or stored in a separate storage.

As another example, if it is determined that there is the new version in the cloud server 10 of the access API specification now being used by the vehicle, the new version of the access API specification registered in the cloud server 10 is transmitted to the access control device 100. The access control device 100 may receive and acquire the new version of the access API specification transmitted from the cloud server 10 at the steps of S2 and S3.

Besides, the processor 120 of the access control device 100 may create a token sequence by analyzing the acquired new version of the access API specification with keywords by using a lexer. The processor 120 may create the parse tree by parsing the created token sequence using a parser.

At the time, the parse tree, as an example, may be created as shown in FIG. 4, which exemplarily illustrates a result of parsing one API. It may include items that define BaseAPI classes, API instances, and parameter instances.

The processor 120 of the access control device 100 may store API instances API1, API2, API3, API4, . . . , and APIN as temporary data already registered and used in the API map of the storage part 130, before the above-mentioned operations, in order to allow the new version of the access API specification to be rollbacked to deal with errors during the course of upgrade, etc.

Next, the processor 120 of the access control device 100 may create one or more API instances corresponding to one or more APIs included in the new version of the access API specification by referring to the parse tree at the steps of S5 and S6 and register the created API instances in the API map of the storage part 130 so that the API instances are available for the user interface of the vehicle at the step of S7.

As one instance, the processor 120 of the access control device 100 may map the parse tree with function items defined in a feature factory at the step of S5 and create API instances at the step of S6.

Herein, the feature factory may be a programming function, e.g., a script function, with keywords used in the new version of the access API specification as variables, which gives properties to items to be used in the API instances.

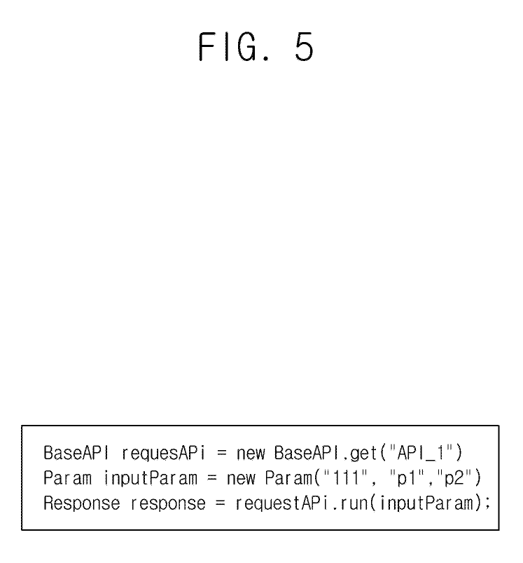

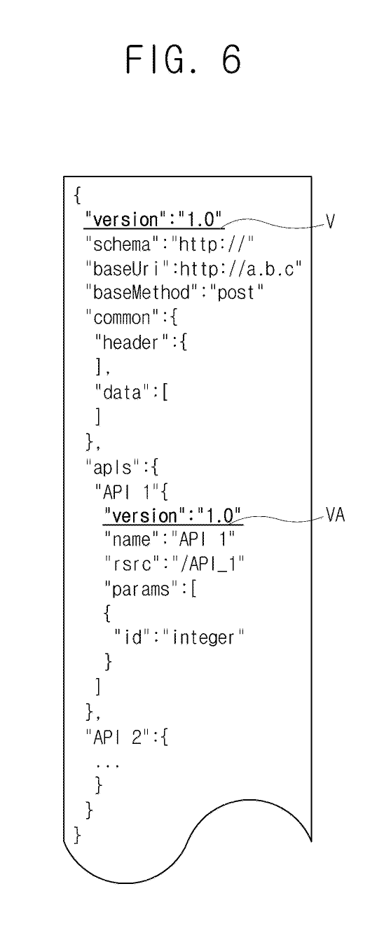

FIG. 5 exemplarily illustrates an API instance created for one API. When the API instance in FIG. 5 is used, an instance for “API1” is brought in (by “requestAPI”) from an API map, e.g., BaseAPI. After parameters “111”, “p1”, and “p2” are designated (by “inputparam”), the instance is executed in a form of calling. In other words, the “API1” instance with parameters of “111”, “p1”, and “p2” is executed.

As such, contrary to upgrade of all API instances corresponding to the new versions of the access API specification, information on versions of individual APIs included in the new version of the access API specification may be checked to upgrade only new versions of API instances or only newly added API instances.

In short, as shown in FIG. 6, the processor 120 of the access control device 100 may create a new version of a specific API instance corresponding to only a new version of a specific API by checking versions VA of individual APIs included in the new versions of the access API specification in addition to version V of the access API specification and upgrade the specific API instance already registered in the API map to the new version of the specific API instance. Herein, an unregistered API instance may be registered in the API map of the storage part 130 as a new version of the API instance under a method as shown above, by setting information on a version of the unregistered API instance as a “null” value, etc.

After the API instance in the API map corresponding to the new version of the access API specification under the method has been upgraded, a function of accessing the cloud in the vehicle is performed using the upgraded API map in order to perform a function defined in the API by a user interaction or by a request from the inside of the vehicle.

In accordance with the present invention, update caused by a change of a function or an addition of a new function is easily done by forming the cloud-based vehicle environment using the API map, based on the access API specification without using a software package whose functions are fixed.

In addition, in accordance with the present invention, the API instance may be created by referring to the new version of the access API specification and register it to the API map so that the API instance is available for the user interface to have access to the cloud without any separate external processing.

Furthermore, the present invention may reduce costs because it is not necessary to update the software package required due to the change of the function or the addition of the new function.

Moreover, the present invention may remove problems of the conventional method of the static software packaging by automatically changing or reconfiguring a function of accessing the cloud network without any separate, external access or operation, and at the same time, provide safety information for driving a vehicle and allow the functions to be extended easily by giving an authority to control the vehicle environment.

The embodiments of the present invention as explained above can be implemented in a form of executable program command through a variety of computer means recordable to computer readable media. The computer readable media may include solely or in combination, program commands, data files, and data structures. The program commands recorded to the media may be components specially designed for the present invention or may be usable to a skilled person in a field of computer software. Computer readable record media include magnetic media such as hard disk, floppy disk, and magnetic tape, optical media such as CD-ROM and DVD, magneto-optical media such as floptical disk and hardware devices such as ROM, RAM, and flash memory specially designed to store and carry out programs. Program commands include not only a machine language code made by a complier but also a high-level code that can be used by an interpreter etc., which is executed by a computer. The aforementioned hardware device can work as more than a software module to perform the action of the present invention and they can do the same in the opposite case.

As seen above, the present invention has been explained by specific matters such as detailed components, limited embodiments, and drawings. They have been provided only to help more general understanding of the present invention. It, however, will be understood by those skilled in the art that various changes and modification may be made from the description.

Accordingly, the thought of the present invention must not be confined to the explained embodiments, and the following patent claims as well as everything including variants equal or equivalent to the patent claims pertain to the category of the thought of the present invention

What is claimed is:

1. A method for automatically controlling a network access by using an API map in a cloud-based environment of a vehicle, comprising steps of:
(a) an access control device transmitting or supporting other device to transmit information on a current version of an access API specification being used by the vehicle to a cloud server to support the cloud server to check whether there is a new version of the access API specification being used;
(b) the access control device, if it is determined that there is the new version of the access API specification being used in the cloud server, acquiring the new version of the access API specification and creating a parse tree by parsing the acquired new version of the access API specification; and
(c) the access control device creating one or more API instances corresponding to one or more APIs included in the new version of the access API specification by referring to the parse tree and registering the created API instances in the API map so that the API instances are available for a user interface of the vehicle.

2. The method of claim 1, wherein, at the step of (b), if it is determined that there is the new version of the access API specification being used and if download information of the new version of the access API specification is acquired from the cloud server, the access control device downloads and acquires the new version of the access API specification corresponding to the download information.

3. The method of claim 1, wherein, at the step of (b), if it is determined that there is the new version of the access API specification being used in the cloud server and if the new version of the access API specification is transmitted from the cloud server, the access control device receives and acquires the new version of the access API specification transmitted from the cloud server.

4. The method of claim 1, wherein, at the step of (c), the access control device creates the API instances by mapping the parse tree with function items defined in a feature factory.

5. The method of claim 4, wherein the feature factory is a programming function, with keywords used in the new version of the access API specification as variables, which gives properties to items to be used in the API instances by referring to the keywords.

6. The method of claim 1, further comprising a step of:
(b01) the access control device storing API instances, which are already registered in the API map and are being used, as temporary data before the step of (b) in order to allow the new version of the access API specification to be rollbacked.

7. The method of claim 1, wherein, at the step of (b), the access control device creates a token sequence by analyzing the new version of the access API specification with keywords by using a lexer and creates the parse tree by parsing the created token sequence by using a parser.

8. The method of claim 1, wherein, if power of the vehicle is fed to the access control device, the access control device performs the step of (a).

9. The method of claim 1, wherein, at the step of (c), the access control device creates a new version of a specific API instance only if there is a new version of a specific API corresponding to the specific API instance in the access API specification by referring to versions of the APIs included in the new version of the access API specification and upgrades the specific API instance already registered in the API map to the new version of the specific API instance.

10. An access control device for automatically controlling a network access by using an API map in a cloud-based environment of a vehicle, comprising:
a communication part for transmitting or supporting other device to transmit information on a current version of an access API specification being used by the vehicle to a cloud server to support the cloud server to check whether there is a new version of the access API specification being used; and
a processor for (i) acquiring the new version of the access API specification, if it is determined that there is the new version of the access API specification being used in the cloud server, and creating a parse tree by parsing the acquired new version of the access API specification and (ii) creating one or more API instances corresponding to one or more APIs included in the new version of the access API specification by referring to the parse tree and registering the created API instances in the API map so that the API instances are available for a user interface of the vehicle.

11. The access control device of claim 10, wherein, it is determined that there is the new version of the access API specification being used and if download information of the new version of the access API specification is acquired from the cloud server, the processor downloads and acquires the new version of the access API specification corresponding to the download information.

12. The access control device of claim 1, wherein, if it is determined that there is the new version of the access API specification being used in the cloud server and if the new version of the access API specification is transmitted from the cloud server, the processor receives and acquires the new version of the access API specification transmitted from the cloud server.

13. The access control device of claim 1, wherein the processor creates the API instances by mapping the parse tree with function items defined in a feature factory.

14. The access control device of claim 13, wherein the feature factory is a programming function, with keywords used in the new version of the access API specification as variables, which gives properties to items to be used in the API instances by referring to the keywords.

15. The access control device of claim 13, wherein the processor stores API instances, which are already registered in the API map and are being used, as temporary data in order to allow the new version of the access API specification to be rollbacked.

16. The access control device of claim 10, wherein the processor creates a token sequence by analyzing the new version of the access API specification with keywords by using a lexer and creates the parse tree by parsing the created token sequence by using a parser.

17. The access control device of claim 10, wherein, if power of the vehicle is fed to the access control device, the access control device performs the operations of (i) and (ii).

18. The access control device of claim 10, wherein the processor creates a new version of a specific API instance only if there is a new version of a specific API corresponding to the specific API instance in the access API specification by referring to versions of the APIs included in the new version of the access API specification and upgrades the specific API instance already registered in the API map to the new version of the specific API instance.
